(19) United States
(12) Patent Application Publication
(10) Pub. No.: US 2007/0220461 A1
(43) Pub. Date: Sep. 20, 2007

(54) Method and system for sequential equivalence checking with multiple initial states

(76) Inventors: Jason R. Baumgartner, Austin, TX (US); Robert L. Kanzelman, Rochester, MN (US); Paul J. Roessler, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/375,476

(22) Filed: Mar. 14, 2006

(51) Int. Cl. G06F 17/50

(52) U.S. Cl. 716/5; 716/4

(57) ABSTRACT

A method, system and computer program product for performing equivalence checking of a circuit design are disclosed. The method includes importing a first design comprising a first register set and a different second design comprising a second register set and importing a mapping between corresponding initial states of the first register set and the second register set. A first random logic and a second random logic, respectively representing an application of a set of initial values to the first register set and the second register set are generated and an equivalence check on a third design synthesized from the first design and the second design with an output set from the first random logic as an initialization of the first register set and with an output set of the second random logic as an initialization of the second register set is performed.

### BACKGROUND OF THE INVENTION

1. Technical Field

The present invention relates in general to verifying designs and in particular to performing equivalence checking. Still more particularly, the present invention relates to a system, method and computer program product for performing sequential equivalence checking with multiple initial states.

2. Description of the Related Art

With the increasing penetration of processor-based systems into every facet of human activity, demands have increased on the processor and application-specific integrated circuit (ASIC) development and production community to produce systems that are free from design flaws. Circuit products, including microprocessors, digital signal and other special-purpose processors, and ASICs, have become involved in the performance of a vast array of critical functions, and the involvement of microprocessors in the important tasks of daily life has heightened the expectation of error-free and flaw-free design. Whether the impact of errors in design would be measured in human lives or in mere dollars and cents, consumers of circuit products have lost tolerance for results polluted by design errors. Consumers will not tolerate, by way of example, miscalculations on the floor of the stock exchange, in the medical devices that support human life, or in the computers that control their automobiles. All of these activities represent areas where the need for reliable circuit results has risen to a mission-critical concern.

In response to the increasing need for reliable, error-free designs, the processor and ASIC design and development community has developed rigorous, if incredibly expensive, methods for testing and verification for demonstrating the correctness of a design. The task of hardware verification has become one of the most important and time-consuming aspects of the design process.

Among the available verification techniques, formal and semiformal verification techniques are powerful tools for the construction of correct logic designs. Formal and semiformal verification techniques offer the opportunity to expose some of the probabilistically uncommon scenarios that may result in a functional design failure, and frequently offer the opportunity to prove that the design is correct (i.e., that no failing scenario exists).

Unfortunately, the resources needed for formal verification, or any verification, of designs are proportional to design size. Formal verification techniques require computational resources which are exponential with respect to the design under test. Similarly, simulation scales polynomially and emulators are gated in their capacity by design size and maximum logic depth. Semi-formal verification techniques leverage formal methods on larger designs by applying them only in a resource-bounded manner, though at the expense of incomplete verification coverage. Generally, coverage decreases as design size increases.

Sequential equivalence checking techniques are generally able to verify that two designs have identical output behavior for any given input stimulus. If this equivalence may be demonstrated, then one design may be replaced with the other without altering the behavior of the overall system. These techniques are useful for applications such as ensuring that manually-performed or automatically-performed design optimizations, which are critical for synthesis, do not alter system behavior.

Most modern designs have a designated initial state, realized in hardware by techniques such as a power-on reset sequence of flushing O-data through a system's scan chains. In a sequential equivalence framework, a system will initialize the two designs into their designated initial states prior to assessing their input-output equivalence. This initialization serves two purposes. First, the technique avoids spurious mismatches that may be encountered if applying the same testcase to the two designs when they are in incompatible initial states or when they are in ‘unreachable’ states (i.e., states which can never be encountered if applying input sequences from the true initial state of the design). Second, this technique avoids invalid ‘no mismatch exists’ results, which may occur because the designs are initialized into an unreachable state, instead of their true initial state.

There are, however, cases in which it is desired to perform an equivalence check from a set of initial states instead of from a single initial state. For example, some registers are not a part of the initialization sequence (e.g., scan chains), and their initial values cannot be determined to be a constant. As another example, most modern designs support various modes of operation, which control the behavior of the design. These modes are often supported by switch registers, into which various initial values are scanned, and which thereafter hold those initial values during functional operation. For robust equivalence checking, one must check the two designs under all corresponding initial value modes.

Unfortunately, randomizing a set of registers across two designs will frequently result in spurious mismatches (if the randomizations are not properly correlated across the two designs). For example, an output of the designs may be a combinational function of several of the registers, which are to be randomized, creating the potential that a mismatch will occur if the randomization of those registers is not correlated across the designs. Additionally, the correspondence of random initial values in the design may be indirect. For example, a mode “011” of design1 could correlate to a mode “100” of design2, possibly because the latches implementing these modes had an inverter “retimed” across them. More generally, a redesign may map any arbitrary mode setting to any other arbitrary mode setting(s).

To compensate for these spurious-mismatch problems, prior-art techniques would require a distinct equivalence check to be run for each corresponding initial state to be checked. Such a series of equivalence checks may be exceedingly inefficient due to both the large number of runs (e.g., given n random latches, there are 2ˆn distinct runs needed, where A denotes exponentiation), and to the fact that such distinct runs require virtually as many resources as would the single run comprising all correspondent states. The prior art does not provide an extensible framework for enabling a single run comprising all corresponding modes to be checked, with as little manual correspondence specification required as possible.

What is needed is a method for performing sequential equivalence checking with multiple initial states.

### SUMMARY OF THE INVENTION

A method, system and computer program product for performing equivalence checking of a circuit design are disclosed. The method includes importing a first design comprising a first register set and a different second design comprising a second register set and importing a mapping between corresponding initial states of the first register set and the second register set. A first random logic and a second random logic, respectively representing an application of a set of initial values to the first register set and the second register set are generated and an equivalence check on a third design synthesized from the first design and the second design with an output set from the first random logic as an initialization of the first register set and with an output set of the second random logic as an initialization of the second register set is performed.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed descriptions of an illustrative embodiment when read in conjunction with the accompanying drawings, wherein:

FIG. 1 depicts a block diagram of a general-purpose data processing system with which the present invention of a method, system and computer program product for performing sequential equivalence checking with multiple initial states may be performed; and

FIG. 2 is a high-level logical flowchart of a process for performing sequential equivalence checking with multiple initial states in accordance with a preferred embodiment of the present invention.

### DETAILED DESCRIPTION OF THE PREFERRED EMBODIMENT

The present invention provides a method, system, and computer program product for performing sequential equivalence checking with multiple initial states. The present invention includes a method for denoting which registers are to have constant and non-constant initial values, for identifying correspondence of initial states of one design to states of the other, and for performing an equivalence check upon the designs with all of their corresponding initial states in parallel. The present invention enables dramatic savings in computational resources for designs with multiple initial states in allowing them to run in parallel, and simplifies the process of specifying nontrivial initial value mappings between the two designs.

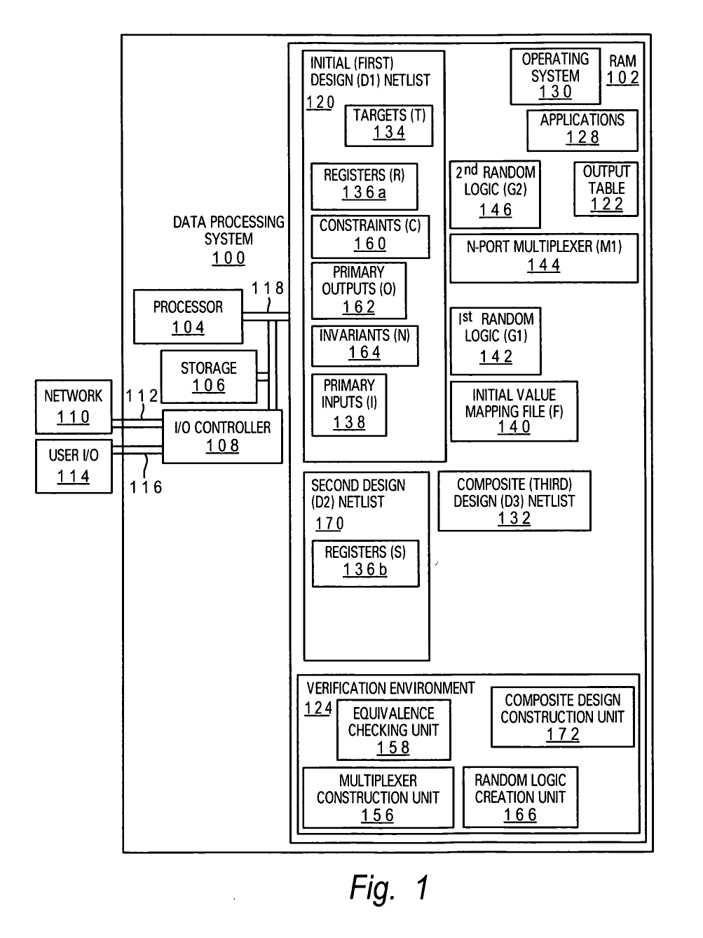

With reference now to the figures, and in particular with reference to FIG. 1, a block diagram of a general-purpose data processing system, in accordance with a preferred embodiment of the present invention, is depicted. Data processing system 100 contains a processing storage unit (e.g., RAM 102) and a processor 104. Data processing system 100 also includes non-volatile storage 106 such as a hard disk drive or other direct-access storage device. An Input/Output (I/O) controller 108 provides connectivity to a network 110 through a wired or wireless link, such as a network cable 112. I/O controller 108 also connects to user I/O devices 114 such as a keyboard, a display device, a mouse, or a printer through wired or wireless link 116, such as cables or a radio-frequency connection. System interconnect 118 connects processor 104, RAM 102, storage 106, and I/O controller 108.

Within RAM 102, data processing system 100 stores several items of data and instructions while operating in accordance with a preferred embodiment of the present invention. These include an initial (first) design (D1) netlist 120 and an output table 122 for interaction with a verification environment 124. In the embodiment shown in FIG. 1, initial design (D1) netlist 120 contains constraints (C) 160, primary outputs (O) 162, invariants (N) 164, targets (T) 134 registers (R) 136a and primary inputs (I) 138. Other applications 128 and verification environment 124 interface with processor 104, RAM 102, I/O control 108, and storage 106 through operating system 130. One skilled in the data processing arts will quickly realize that additional components of data processing system 100 may be added to or substituted for those shown without departing from the scope of the present invention. Other data structures in RAM 102 include second design (D2) netlist 170 containing registers (S) 136b, composite (third) design (D3) netlist 132, initial value mapping file (F) 140, first random logic (GI) 142, n-port multiplexor (M1) 144, and second random logic (G2) 146.

A netlist (such as initial (first) design (D1) netlist 120, second design (D2) netlist 170, or composite (third) design (D3) netlist 132) is a popular means of compactly representing problems derived from circuit structures in the computer-aided design of digital circuits. All three of initial (first) design (D1) netlist 120, second design (D2) netlist 170, and composite (third) design (D3) netlist 132 contain representations of similar types of components, though, for simplicity, some components are only shown with respect to initial (first) design (D1) netlist 120. Hereafter, a type of netlist component may be referred to by its reference number as represented in initial (first) design (D1) netlist 120, even if instances of that component exist and are operated upon in second design (D2) netlist 170, or composite (third) design (D3) netlist 132.

A netlist representation is non-canonical and offers the ability to analyze the function from the nodes in the graph. Initial (first) design (D1) netlist 120, second design (D2) netlist 170, and composite (third) design (D3) netlist 132 contain directed graphs with vertices representing gates and edges representing interconnections between those gates. The gates have associated functions, such as constants, primary inputs (I) 138 (e.g. RANDOM gates, which deliver random values at the given input), combinational logic (e.g., AND gates), and sequential elements (hereafter referred to as registers (R) 136). Registers (R) 136 have two associated components; their next-state functions and their initial-value functions, which are represented as other gates in the graph. Certain gates in the netlist may be labeled as primary outputs (0) 162, invariants (N) 164, targets (T) 134 and constraints (C) 160.

Semantically, for a given register (R) 136, the value appearing at its initial-value gate at time “0” (“initialization” or “reset” time) will be applied by verification environment 124 as the value of the register (R) 136 itself; the value appearing at its next-state function gate at time “i” will be applied to the register itself at time “i+1”. Certain gates are labeled as targets (T) 134 or constraints (C) 160. Targets (T) 134 correlate to the properties that require verification. Constraints (C) 160 are used to artificially limit the stimulus that can be applied to the RANDOM gates of initial (first) design (D1) netlist 120, second design (D2) netlist 170, and composite (third) design (D3) netlist 132; in particular, when searching for a way to drive a “1” to a target (T) 134, verification environment 124 must adhere to rules such as, for purpose of example, that “every constraint gate must evaluate to a logical 1 for every time-step” or “every constraint gate must evaluate to a logical 1 for every time-step up to, and including, the time-step at which the target is asserted.” For example, in verification environment 124, a constraint (C) 160 could be added which drives a 1 exactly when a vector of RANDOM gates appears, to simulate even parity. Without constraints (C) 160, verification environment 124 would consider valuations with even or odd parity to those RANDOM gates; with constraints (C) 160, only even parity would be explored.

Invariants (N) 164 are similar to constraints in the sense that they will always evaluate to a “1”. However, unlike constraints (C) 160, they will naturally evaluate to a 1 even if discarded from the problem formulation (i.e., they are redundant facts about the way the design will behave due to its structural definition). These redundant facts may be useful in formal verification to obtain proofs of correctness. For example, an invariant (N) 164 node could assert that a set of registers (R) 136a always evaluates to even parity; that fact may help the performance of proof-based techniques.

Note that this netlist format allows for non-constant initial values. For example, assume that initial design (D1) netlist 120 has three “switch” registers (R) 136a (e.g. R1, R2, R3) in the design, which are nondeterministically initialized to “000”, “001”, “010”, “011”, “100”, “101”, and “110” (i.e., to all values other than “111”). This initialization can be specified by giving R1 and R2 unique “inputs” I1 and I2 (which are not primary inputs 138) as initial values, and defining the initial value of R3 as the value of a unique input (13 AND NOT(I1 AND I2)). In other words, all cross-products of initial values of R1, R2 and R3 are possible, except that when “(I1 AND I2)=1”, verification environment 124 will disallow R3 from initializing to 1. Note that, in some embodiments, verification environment 124 may synthesize such logic automatically given the set of values to be produced at the initial value gates, which in some embodiments may be implemented by mapping the values to be produced as the “range” of a relation into a binary decision diagram, then into gates.

In a sequential equivalence checking framework, verification environment 124 will build composite design (D3) netlist 132 over initial design (D1) netlist 120 and second design (D2) netlist 170 by correlating their inputs (I) 138 (i.e., by replacing inputs (I) 138 of one by inputs (I) 138 of the other), by building an XOR target (T) 134 over correlated outputs (O) 162, and by attempting to prove that each of the XORs is not assertable. An additional novel aspect of the present invention is that, in addition to correlating inputs (I) 138 and outputs (O) 162, verification environment 124 can correlate initial values of registers (R) 136a and registers (S) 136b across initial design (D1) netlist 120 and second design (D2) netlist 170.

Because the format of initial (first) design (D1) netlist 120, second design (D2) netlist 170, and composite (third) design (D3) netlist 132 includes both initial values and next-state functions for each of registers (R) 136 and registers (S) 136b, this netlist format may be imported into a verification toolset (or a sequential equivalence checking toolset) within verification environment 124, and verification or sequential equivalence checking can performed with respect to those initial states.

Processor 104 executes instructions from programs, often stored in RAM 102, in the course of performing the present invention. In a preferred embodiment of the present invention, processor 104 executes verification environment 124. Verification environment 124 contains a random logic creation unit 166, a multiplexer construction unit 156, an equivalence checking unit 158, and a composite design construction unit 172.

The present invention allows the specification of correlated initial values across initial design (D1) netlist 120 and second design (D2) netlist 170 for equivalence-checking and accommodates two types of initialization. First, verification environment 124 accomodates cases cases in which a register (R) 136a of initial design (D1) netlist 120 is to be initialized identically to register (S) 136b of second design (D2) netlist 170. For example, take the above-described case, in which registers (R) 136a R1, R2 and R3 of design (D1) netlist 120 are to be initialized into all possible initial values other than “111”. Assume that three registers (S) 136b S1, S2, and S3 of second design (D2) netlist 170 are also to be initialized into all possible initial values other than “111”. Assume further that registers (S) 136b S1, S2 and S3 of second design (D2) netlist 170 are to be initialized to the identical valuation into which registers (R) 136a R1, R2 and R3 of initial design (D1) netlist 120 are initialized.

The present invention supports this case by allowing the user to provide a mapping in initial value mapping file (F) 140 between registers (R) 136a R1, R2 and R3 of initial design (D1) netlist 120 and registers (S) 136b S1, S2 and S3 of design (D2) netlist 170. For example, mapping file (F) 140 could contain the data shown below:
R1→S1
R2→S2
R3→S3
   Once verification environment 124 parses mapping file (F) 140, verification environment 124 disconnects the initial value gates for mapped registers (S) 136b in second design (D2) netlist 170, and “reconnects” those registers (S) 136b to the corresponding initial value gates of initial design (D1) netlist 120. In other words, verification environment 124 disconnects the original initial value gate of S1 and reconnects it to the initial value gate of R1, performing similarly for S2/R2, and S3/R3.

Additionally, verification environment 124 supports two options for initialization of registers (R) 136a R1, R2 and R3 (upon which the initialization of registers (S) 136b S1, S2 and S3 will be derived by verification environment 124). The first option is that the initialization of registers (R) 136a R1, R2, R3 can be “inherited” from initial design (D1) netlist 120. The second option is that any registers (R) 136a appearing in mapping file (F) 140 for the initial design (D1) netlist 120 can be automatically assumed by verification environment 124 to be randomized, and verification environment 124 can automatically create and connect a distinct primary input 138 as the initial value gate for initial design (D1) netlist 120 prior to reconnecting that initial value to second design (D2) netlist 170.

Verification environment 124 supports correlating a set of initial values for registers (S) 136b of second design (D2) netlist 170 with a set of initial values for registers (R) 136a of initial design (D1) netlist 120, thereby providing an option that may be attractive if registers (R) 136a of initial design (D1) netlist 120 and registers (S) 136b of second design (D2) netlist 170 or their corresponding values are not 1:1. While this case actually subsumes the prior case, the format of mapping file (F) 140 for this case is more involved (hence more manual specification effort is required from users). Both modes are useful.

The present invention enables the correlation of a set of initial values of second design (D2) netlist 170 to a set of initial values of initial design (D1) netlist 120. The file format of the mapping file (F) 140 for this purpose consists of records of the following form:
{set R′ of registers of design1}→{set S′ of registers of design2}
{first set of initial values of R′}→{first set of corresponding initial values of S′}
{second set of initial values of R′}→{second set of corresponding initial values of S′}
{n-th set of initial values of R′}→{n-th set of corresponding initial values of S′}
   In the case that the initial value sets of R′ in mapping file (F) 140 are not disjoint, verification environment 124 may automatically pre-process mapping file (F) 140 to ensure disjointness. To accomplish disjointness, verification environment 124 will cause the resulting mapping file (F) 140 to have only a single initial value for R′ in each “entry”. The set of initial values of S′ correlating to the single initial value of R′ for that entry will be specified as the set of all S′ values in the original file for which that initial value of R′ appeared. In other words, if an initial value for R′ appeared in only a single row of the original mapping file (F) 140, verification environment 124 will directly reuse the corresponding set of initial values for S′ for that entry. If an initial value appeared in multiple rows of the original mapping file (F) 140, verification environment 124 takes the union of all S′ initial values from the corresponding rows of the original mapping file (F) 140 as the mapped set.

Application of the resulting mapping file (F) 140 has several effects upon the sequential equivalence check. Application of the resulting mapping file (F) 140 will create a set of replacement initial value gates for S′ as a function of those for R′. This set is a synthesis of the provided mapping file (F) 140. In particular, for any initial value of R′, there will be one or more initial values into which S′ may be initialized. If there is at most one element of S′ for each initial value of R′, the replacement logic is a deterministic “filter” which may be synthesized by verification environment 124. Verification environment 124 creates an n-bit (where there are n registers in S′) multiplexor (n-port multiplexor (M1) 144) whose outputs are the initial values for S′. The selectors of this n-port multiplexor (M1) 144 are the initial values of R′. Assuming there are m registers in R′, there will be 2ˆm input data ports for n-port multiplexor (M1) 144, where the i-th port is “selected” if R′ evaluates to ‘T’. The i-th data port has the data value for S′ from the mapping file (F) 140 which correlates to value ‘I’ upon R′.

Note that some values of R′ may be unspecified in mapping file (F) 140, hence will be unmapped to values of S′. Verification environment 124 may interpret this condition as meaning that the mapping from such unspecified R′ values to S′ values can be arbitrary, and the synthesis of this “filter” may place arbitrary values upon the corresponding data ports for n-port multiplexor (M1) 144. Note that the logic of n-port multiplexor (M1) 144 may be optimized by verification environment 124 to reduce its gate count such that this ‘don't caring’ may enable greater reductions. Second, verification environment 124 may interpret this condition as meaning that “such values are not producible as initial values to R′”, which also implies the applicability of such values as don't cares. Finally, verification environment 124 may interpret this condition such that “unspecified mappings are 1:1” (though this requires the cardinality of R′ and S′ to be identical). In such a case, there are effectively no unspecified mappings and the preprocessing of mapping file (F) 140 may fill in such cases by adding 1:1 R′ to S′ mapping entries for all unspecified values of R′.

In general, there may be multiple S′ initial values for a given R′ initial value. Such a mapping may be implemented in mapping file (F) 140 by verification environment 124 first creating a set of gates that is able to produce exactly the same set of values as the S′ domain to which mapping is being made. As may be implied by the above example of multiple initial values in initial design (D1) netlist 120, verification environment 124 can create such logic given the list of values to be produced. Once created by verification environment 124, the corresponding gates may be used to drive the corresponding i-th data port of n-port multiplexor (M1) 144, just as would a deterministic constant pattern if the R′ to S′ mapping were 1:1.

Overall, this use by verification environment 124 of a synthesis process is a preferred embodiment to implement the R′ to S′ relation implicit in mapping file (F) 140. In an alternative embodiment, verification environment 124 may also directly synthesize this “filter” logic, by mapping the relation to a binary decision diagram and then into gates. Once the synthesis is completed, verification environment 124 will disconnect the initial value gates of S′, and reconnect them to the corresponding gates created in the synthesis. Verification environment 124 will then optionally create the initialization logic for initial design (D1) netlist 120 (if this initialization logic is not to be inherited from the original specification of initial design (D1) netlist 120). As per the above example of multiple initial values in a netlist, verification environment 124 may create such logic given the list of initial values to be produced for R′. This list can be used to represent all of the values specified for R′ in the mapping to S′.

An overall flow of the present invention can be specified by the following two examples of pseudocode. A first pseudocode represents steps usable if inheriting initial values from the original design specification:
import design 1 and design 2
correlate inputs and outputs of design 1 and design 2 in a composite netlist representation
import initial value mapping file
synthesize filter logic representing the mapping from initial values of design 1 to initial values of design 2
replace the initial values of design 2 with the synthesized logic
perform equivalence checking on resulting modified design

A second pseudocode represents steps usable if creating initial values for design 1 using the mapping file:
import design 1 and design 2
correlate inputs and outputs of design1 and design2 in a composite netlist representation
import initial value mapping file
synthesize initial value logic from mapping file for gates in design1
replace mapped initial value gates from design1 with synthesized initial value logic
synthesize filter logic representing the mapping from initial values of design 1 to initial values of design 2
replace the initial values of design 2 with the synthesized logic
perform equivalence checking on resulting modified design

As described, mapping file (F) 140 is often provided by a user of verification environment 124 to reflect the initial value correspondence suspected across second design (D2) netlist 170 and initial design (D1) netlist 120. However, in an alternate embodiment, mapping file (F) 140 may be automatically generated by verification environment 124. For example, verification environment 124 may first attempt to randomize and correlate all initial values of registers (R) 136a and registers (S) 136b, then in response to detecting a failure in the equivalence check, may attempt to prune the correspondence of the particular initial values of registers (R) 136a and registers (S) 136b illustrated in the failed equivalence check. As another example, verification environment 124 may use name-based, structural, or hierarchical information to guess the correlation among the states of registers (R) 136a and registers (S) 136b.

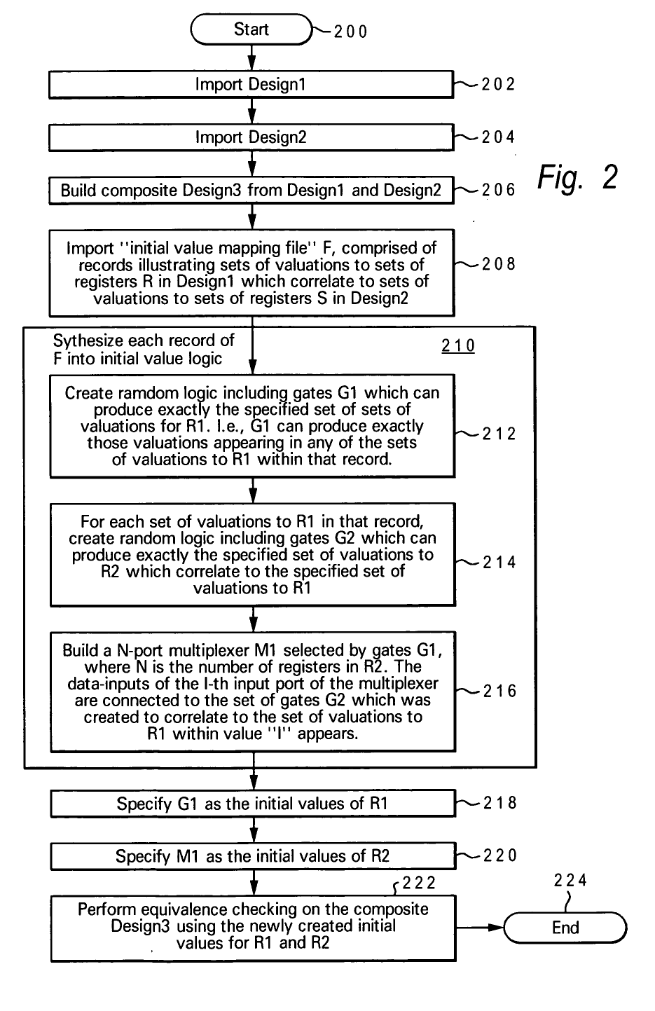

Turning now to FIG. 2, a high-level logical flowchart of a process for parametric reduction of sequential designs is depicted. The process starts at step 200 and then proceeds to step 202, which depicts verification environment 124 importing initial design (D1) netlist 120, labeled in the flowchart as Design1. The process next moves to step 204. Step 204 illustrates verification environment 124 importing second design (D2) netlist 170, labeled in the flowchart as Design2. The process then proceeds to step 206, which depicts composite design construction unit 172 building composite (third) design (D3) netlist 132, labeled in the flowchart as Design3, from initial design (D1) netlist 120 and second design (D2) netlist 170. The process next moves to step 208. Step 208 illustrates verification environment importing mapping file (F) 140, which is comprised of the sets of valuations to sets of registers (R) 136a in initial design (D1) netlist 120 that correlate to sets of valuations to sets of registers (S) 136b in second design (D2) netlist 170.

The process then proceeds to macro-step 210, which is composed of steps 212-216 and illustrates verification environment 124 synthesizing each record of mapping file (F) 140 into initial value logic. Steps 212-216 are repeated for each record of mapping file (F) 140. Step 212 depicts random logic creation unit 166 creating first random logic (G1) 142, which can exactly produce the specified set of sets of valuations for registers (R) 136a. First random logic (G1) 142 can produce exactly those valuations appearing in any of the sets of valuations to first registers (R) 136a within a given record. The process next moves to step 214, which illustrates random logic creation unit 166, for each set of valuations to registers (R) 136a, creating second random logic (G2) 146, which can produce exactly the specified set of valuations to registers (S) 136b that correlate to the specified set of valuations to registers (R) 136a. The process then proceeds to step 216. Step 216 depicts multiplexer construction unit 156 building N-port multiplexer (M1) 144 selected by gates of first random logic (G1) 142. In N-port multiplexer (M1) 144, the data inputs of the i-th input port of the multiplexer are connected to the set of gates in second random logic (G2) 146, which were created to correlate to the set of valuations of registers (R) 136a within which the ‘i’ value appears. Once steps 212-216 are completed for each record of mapping file (F) 140, the process next moves to step 218.

Step 218 depicts verification environment 124 designating first random logic (GI) 142 as the initial values of registers (R) 136a. The process then proceeds to step 220, which illustrates verification environment 124 designating first N-port multiplexer (M1) 144 as the initial values of registers (S) 136b. The process next moves to step 222. Step 222 depicts verification environment 124 performing equivalence checking on composite (third) design (D3) netlist 132 using the newly created initial values of registers (S) 136b and registers (R) 136a. The process then ends at step 224.

While the invention has been particularly shown as described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communication links.

What is claimed is:

1. A method for performing equivalence checking of a circuit design, said method comprising:
importing a first design comprising a first register set and a different second design comprising a second register set;
importing a mapping between corresponding initial states of said first register set and said second register set;
generating a first random logic and a second random logic, respectively representing an application of a set of initial values to said first register set and said second register set; and
performing an equivalence check on a third design synthesized from said first design and said second design with an output set from said first random logic as an initialization of said first register set and with an output set from said second random logic as an initialization of said second register set.

2. The method of claim 1, wherein:
said step of generating said first random logic further comprises synthesizing said first random logic to include a set of output gates that produces exactly one or more specified sets of valuations for said first register set from said mapping;
said step of generating said second random logic further comprises synthesizing said second random logic to include a set of output gates which produces exactly one or more specified sets of valuations for said second register set from said mapping.

3. The method of claim 1, wherein said step of generating said second random logic further comprises synthesizing said second random logic to produce exactly a set of specified valuations to said second set of registers that correlate to said specified set of valuations in said first set of registers in said mapping.

4. The method of claim 1, wherein said step of importing said mapping further comprises deriving said mapping as a set of records, wherein each record is a set of valuations to said first register which correlate to a set of valuations to said second set of registers.

5. The method of claim 1, wherein said step of importing said mapping further comprises receiving said mapping from a user.

6. The method of claim 1, wherein said step of importing said mapping further comprises said equivalence checking system automatically creating said mapping.

7. The method of claim 1, wherein said step of performing an equivalence check on a third design further comprises checking equivalence concurrently across multiple initial states.

8. A system for performing equivalence checking of a circuit design, said system comprising:
means for importing a first design comprising a first register set and a different second design comprising a second register set;
means for importing a mapping between corresponding initial states of said first register set and said second register set;
means for generating a first random logic and a second random logic, respectively representing an application of a set of initial values to said first register set and said second register set; and
means for performing an equivalence check on a third design synthesized from said first design and said second design with an output set from said first random logic as an initialization of said first register set and with an output set from said second random logic as an initialization of said second register set.

9. The system of claim 8, wherein:
said means for generating said first random logic further comprises means for synthesizing said first random logic to include a set of output gates that produces exactly one or more specified sets of valuations for said first register set from said mapping;
said means for generating said second random logic further comprises means for synthesizing said second random logic to include a set of output gates which produces exactly one or more specified sets of valuations for said second register set from said mapping.

10. The system of claim 8, wherein said means for generating said second random logic further comprises means for synthesizing said second random logic to produce exactly a set of specified valuations to said second set of registers that correlate to said specified set of valuations in said first set of registers in said mapping.

11. The system of claim 8, wherein said means for importing said mapping further comprises means for deriving said mapping as a set of records, wherein each record is a set of valuations to said first register which correlate to a set of valuations to said second set of registers.

12. The system of claim 8, wherein said means for importing said mapping further comprises means for receiving said mapping from a user.

13. The system of claim 8, wherein said means for importing said mapping further comprises means for said equivalence checking system automatically creating said mapping.

14. The system of claim 8, wherein said means for performing an equivalence check on a third design further comprises means for checking equivalence concurrently across multiple initial states.

15. A machine-readable medium having a plurality of instructions processable by a machine embodied therein, wherein said plurality of instructions, when processed by said machine, causes said machine to perform a method, comprising:
importing a first design comprising a first register set and a different second design comprising a second register set;
importing a mapping between corresponding initial states of said first register set and said second register set;
generating a first random logic and a second random logic, respectively representing an application of a set of initial values to said first register set and said second register set; and
performing an equivalence check on a third design synthesized from said first design and said second design with an output set from said first random logic as an initialization of said first register set and with an output set from said second random logic as an initialization of said second register set.

16. The machine-readable medium of claim 15, wherein:
said step of generating said first random logic further comprises synthesizing said first random logic to include a set of output gates that produces exactly one or more specified sets of valuations for said first register set from said mapping;
said step of generating said second random logic further comprises synthesizing said second random logic to include a set of output gates which produces exactly one or more specified sets of valuations for said second register set from said mapping.

17. The machine-readable medium of claim 15, wherein said step of generating said second random logic further comprises synthesizing said second random logic to produce exactly a set of specified valuations to said second set of registers that correlate to said specified set of valuations in said first set of registers in said mapping.

18. The machine-readable medium of claim 15, wherein said step of importing said mapping further comprises deriving said mapping as a set of records, wherein each record is a set of valuations to said first register which correlate to a set of valuations to said second set of registers.

19. The machine-readable medium of claim 15, wherein said step of importing said mapping further comprises receiving said mapping from a user.

20. The machine-readable medium of claim 15, wherein said step of importing said mapping further comprises said equivalence checking system automatically creating said mapping.
